(19) United States
(12) Patent Application Publication
(10) Pub. No.: US 2026/0260161 A1
(43) Pub. Date: Sep. 3, 2026

(54) LEARNING DEVICE, ESTIMATION DEVICE, LEARNING METHOD, AND LEARNING PROGRAM

(71) Applicant: NTT, Inc., Tokyo (JP)

(72) Inventors: Noboru HARADA, Musashino-shi, Tokyo (JP); Yasunori OISHI, Musashino-shi, Tokyo (JP); Daisuke NIIZUMI, Musashino-shi, Tokyo (JP); Daiki TAKEUCHI, Musashino-shi, Tokyo (JP)

(73) Assignee: NTT, Inc., Tokyo (JP)

(21) Appl. No.: 19/155,963

(22) PCT Filed: Feb. 28, 2023
(86) PCT No.: PCT/JP2023/007395

§ 371 Date: Aug. 13, 2025

(51) Int. Cl. G06N 20/00

(52) U.S. Cl. CPC G06N 20/00

(57) ABSTRACT

A learning device includes a learning acquisition unit that acquires a first data group for learning and a second data group for learning constituted of a smaller number of data than the number of data belonging to the first data group for learning, a calculation unit that calculates a first covariance matrix that is a covariance matrix of output values of a first evaluation function utilized when machine learning is executed using the first data group for learning and calculates a second covariance matrix that is a covariance matrix of output values of a second evaluation function utilized when the machine learning is executed using the second data group for learning, and a setting unit that calculates a weight for at least one of the first evaluation function and the second evaluation function. Further, there is a learning unit that generates a learned model.

### TECHNICAL FIELD

The disclosed technique relates a learning device, an estimation device, a learning method, and a learning program.

### BACKGROUND ART

When generating a learned model using a machine learning technique, if statistical distribution (hereinafter simply referred to as “distribution”) of learning data already obtained is matched with the distribution of the data at the time of estimation, a learned model can be generated that can process the data at the time of estimation with high accuracy. However, in practice, only learning data having a distribution different from the distribution of the data at the time of estimation is often obtained.

For example, there is a case in which data observed by observation equipment 1 is used at the time of learning and on the other hand data observed by observation equipment 2 must be used as input data at the time of actual estimation. For example, when switching is made from an old camera which is the observation equipment 1 to a new camera which is the observation equipment 2, it is assumed that a large amount of data photographed by the old camera exists and on the other hand a small amount of data photographed by the new camera exists. In this case, the learned model must be generated under an unbalanced condition that the data photographed by the new camera is extremely less than the data photographed by the old camera. In this case, the learned model is generated by using a large amount of data photographed by the old camera and a small amount of data photographed by the new camera, and at the time of estimation, data in which both the data photographed by the old camera and the data photographed by the new camera are mixed must be processed by using the learned model.

In addition, as another example, it is also assumed that a large amount of data observed from a machine 1 existing in a factory is obtained and on the other hand a small amount of data observed from the same type of machine 2 existing in another factory is obtained. In this case, there is a case for generating the learned model by assuming that the data observed by the machine 1 and the data observed by the machine 2 exist in a comparable number. When a distribution of data observed from the machine 1 and a distribution of data observed from the machine 2 are comparable with respect to a distribution of data assumed at the time of estimation, it is desirable that the learned model is generated after correcting deviation of data amount as mentioned above.

As a conventionally known technique, there is, for example, a technique for evaluating an abnormality by using a Mahalanobis distance (for example, see NPL 1). In this technique, when the learned model is generated, variance of errors outputted from an evaluation function is calculated in advance. Then, in this technique, the data outputted from the learned model is corrected at the time of estimation on the basis of the variance of the error calculated at the time of learning.

### CITATION LIST

### Non Patent Literature

[NPL 1] Tsuyoshi Ide, Masashi Sugiyama, “Machine Learning Professional Series Abnormality Detection and Change Detection”, Published by Kodansha Ltd., 2015, (P15-P21)

### SUMMARY OF INVENTION

### Technical Problem

As mentioned above, even when only the learning data having a distribution different from the distribution of the data obtained at the time of estimation is obtained, it is desirable to generate the learned model by assuming the distribution of the data obtained at the time of estimation.

However, the technique of NPL 1 only corrects the data outputted from the learned model at the time of estimation, and there is a problem that the learned model cannot be generated by assuming the distribution of the data obtained at the time of estimation.

The disclosed technique has been made in view of the above-described point, and it is an object to provide a learning device, an estimation device, a learning method, and a learning program capable of generating a learned model by assuming a distribution of data obtained at the time of estimation even when only learning data having a distribution different from a distribution of data obtained at the time of estimation is obtained.

### Solution to Problem

A first aspect of the present disclosure is a learning device that includes a learning acquisition unit that acquires a first data group for learning and a second data group for learning constituted of a smaller number of data than the number of data belonging to the first data group for learning, a calculation unit that calculates a first covariance matrix that is a covariance matrix of output values of a first evaluation function when each of a plurality of pieces of first learning data belonging to the first data group for learning is inputted to the first evaluation function utilized when machine learning is executed using the first data group for learning and calculates a second covariance matrix that is a covariance matrix of output values of a second evaluation function when each of a plurality of pieces of second learning data belonging to the second data group for learning is inputted to the second evaluation function utilized when the machine learning is executed using the second data group for learning, a setting unit that calculates a weight for at least one of the first evaluation function and the second evaluation function based on a value obtained from the first covariance matrix and a value obtained from the second covariance matrix and sets an entire evaluation function constituted by including the weight, the first evaluation function, and the second evaluation function, and a learning unit that generates a learned model by learning a learning model based on the first data group for learning, the second data group for learning, and the entire evaluation function.

A second aspect of the present disclosure is a learning method in which a computer executes processing of acquiring a first data group for learning and a second data group for learning constituted of smaller data than the number of data belonging to the first data group for learning, calculating a first covariance matrix that is a covariance matrix of output values of a first evaluation function when each of a plurality of pieces of first learning data belonging to the first data group for learning is inputted to the first evaluation function utilized when machine learning is executed using the first data group for learning, calculating a second covariance matrix that is a covariance matrix of output values of a second evaluation function when each of a plurality of pieces of second learning data belonging to the second data group for learning is inputted to the second evaluation function utilized when the machine learning is executed using the second data group for learning, calculating a weight for at least one of the first evaluation function and the second evaluation function based on a value obtained from the first covariance matrix and a value obtained from the second covariance matrix and setting an entire evaluation function constituted by including the weight, the first evaluation function, and the second evaluation function, and generating a learned model by learning a learning model based on the first data group for learning, the second data group for learning, and the entire evaluation function.

A third aspect of the present disclosure is a learning program that causes a computer to execute processing of acquiring a first data group for learning and a second data group for learning constituted of smaller data than the number of data belonging to the first data group for learning, calculating a first covariance matrix that is a covariance matrix of output values of a first evaluation function when each of a plurality of pieces of first learning data belonging to the first data group for learning is inputted to the first evaluation function utilized when machine learning is executed using the first data group for learning, calculating a second covariance matrix that is a covariance matrix of output values of a second evaluation function when each of a plurality of pieces of second learning data belonging to the second data group for learning is inputted to the second evaluation function utilized when the machine learning is executed using the second data group for learning, calculating a weight for at least one of the first evaluation function and the second evaluation function based on a value obtained from the first covariance matrix and a value obtained from the second covariance matrix and setting an entire evaluation function constituted by including the weight, the first evaluation function, and the second evaluation function, and generating a learned model by learning a learning model based on the first data group for learning, the second data group for learning, and the entire evaluation function.

### Advantageous Effects of Invention

According to the disclosed technique, the effect is obtained, in which a learned model can be generated by assuming a distribution of data obtained at the time of estimation, even when only learning data having a distribution different from a distribution of data obtained at the time of estimation is obtained.

### BRIEF DESCRIPTION OF DRAWINGS

FIG. 1 is a block diagram showing one example of a hardware configuration of a customer number prediction device according to a first embodiment.

FIG. 2 is a block diagram showing one example of a functional configuration of the customer number prediction device according to the first embodiment.

FIG. 3 is a diagram for explaining an operation of a learning device according to an embodiment.

FIG. 4 is a diagram for explaining an operation of the learning device according to the embodiment.

FIG. 5 is a diagram for explaining an example.

FIG. 6 is a diagram for explaining the example.

FIG. 7 is a diagram for explaining a modification example.

FIG. 8 is a diagram for explaining the modification example.

### DESCRIPTION OF EMBODIMENTS

Hereinafter, one example of embodiments of the disclosed technique will be described with reference to the drawings. Note that, in the drawings, the same or equivalent constituent elements and parts are given the same reference signs. In addition, dimensional ratios in the drawings are exaggerated for convenience of description and may differ from the actual ratios.

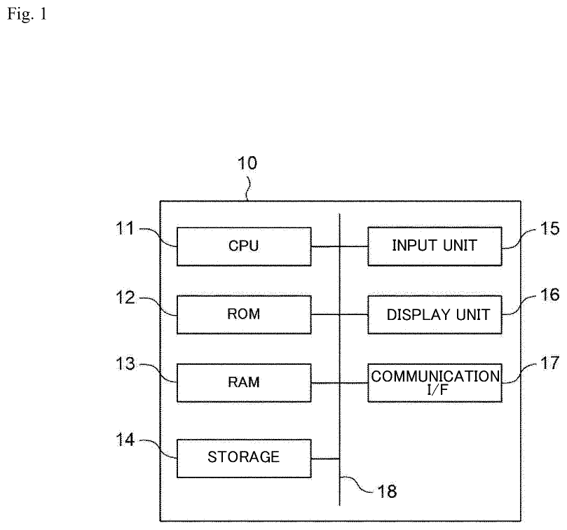

First, a hardware configuration of a learning device 10 according to a present embodiment will be described with reference to FIG. 1.

FIG. 1 is a block diagram showing one example of the hardware configuration of the learning device 10 according to the present embodiment.

As shown in FIG. 1, the learning device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The respective components are communicably connected with each other via a bus 18.

The CPU 11 is a central processing unit and executes various programs or controls each unit. That is, the CPU 11 reads out the program from the ROM 12 or the storage 14 and executes the program using the RAM 13 as a work region. The CPU 11 performs control of above-described each configuration and various types of arithmetic processing in accordance with the programs stored in the ROM 12 or the storage 14. In the present embodiment, a learning program and an estimation program are stored in the ROM 12 or the storage 14.

The ROM 12 stores various programs and various types of data. The RAM 13 temporarily stores the program or data as a work region. The storage 14 is constituted by an HDD (Hard Disk Drive) or an SSD (Solid State Drive) and stores various programs including an operating system and various types of data.

The input unit 15 includes a pointing device such as a mouse and a keyboard, and is used to provide various inputs to own device.

The display unit 16 is, for example, a liquid crystal display and displays various types of information. The display unit 16 may also adopt a touch panel system and function as the input unit 15.

The communication interface 17 is an interface for allowing own device to perform communication with external equipment. For such communication, for example, a wired communication standard such as Ethernet (registered trademark) or FDDI (Fiber Distributed Data Interface), or a wireless communication standard such as 4G, 5G, or Wi-Fi (registered trademark) is used.

A general-purpose computer device such as a server computer or a personal computer (PC) is applied to the learning device 10 according to the present embodiment, for example.

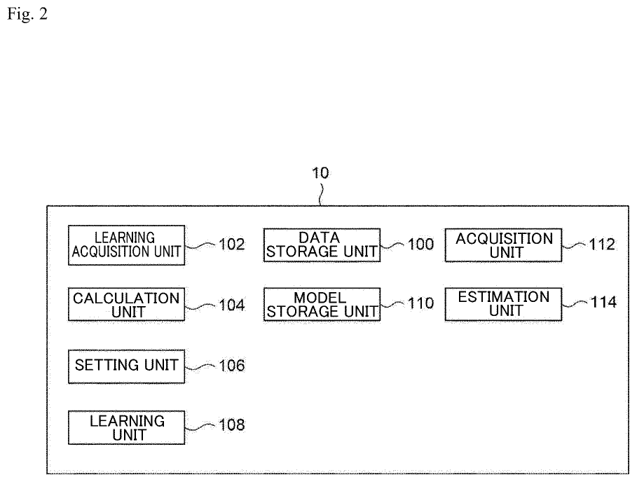

Next, a functional configuration of the learning device 10 will be described with reference to FIG. 2.

FIG. 2 is a block diagram showing one example of the functional configuration of the learning device 10 according to the present embodiment.

As shown in FIG. 2, the learning device 10 includes, as a functional configuration, a data storage unit 100, a learning acquisition unit 102, a calculation unit 104, a setting unit 106, a learning unit 108, a model storage unit 110, an acquisition unit 112, and an estimation unit 114. Each functional configuration is realized by the CPU 11 reading out a learning program and an estimation program stored in the ROM 12 or the storage 14, deploying it on the RAM 13, and executing it.

For example, a case where a learned model is generated on the basis of learning data belonging to an event A and learning data belonging to an event B will be considered. In this case, even when the number of learning data belonging to the event B is overwhelmingly smaller than the number of learning data belonging to the event A, sometimes it is assumed that the event A and the event B occur with comparable probability (or that the event A and the event B occur in the ratio of a:b) at the time of estimation. In this case, even when the number of learning data belonging to the event B obtained at the time of learning is smaller than the number of learning data belonging to the event A obtained at the time of learning, it is preferable to generate the learned model on the assumption that the event A and the event B occur with comparable probability at the time of estimation.

Therefore, even when only biased learning data different from the distribution of data at the time of estimation is obtained, the learning device 10 of the present embodiment executes machine learning processing by assuming the distribution of data at the time of estimation.

In addition, even when only information regarding whether data belonging to the event A is inputted to the learned model or whether data belonging to the event B is inputted to the learned model is not provided at the time of estimation (so-called, called “domain generalization problem”), the learning device 10 of the present embodiment executes the machine learning processing for obtaining a useful learned model.

Hereinafter, specific description will be given. In the following, the case where the number of learning data belonging to the event A is 990 and the number of learning data belonging to the event B is 10 will be described as an example.

The data storage unit 100 stores a first data group for learning belonging to the event A and a second data group for learning belonging to the event B. The second data group for learning is constituted of a smaller number of data than the number of data belonging to the first data group for learning. In the present embodiment, as mentioned above, the first data group for learning is constituted of 990 pieces of data, and the second data group for learning is constituted of 10 pieces of data.

The learning acquisition unit 102 acquires the first data group for learning and the second data group for learning from the data storage unit 100.

The calculation unit 104 acquires a plurality of pieces of first learning data by performing sampling that allows duplication from the first data group for learning acquired by the learning acquisition unit 102. In addition, the calculation unit 104 also acquires a plurality of pieces of second learning data of approximately the same number as the plurality of pieces of first learning data by performing the sampling that allows the duplication from the second data group for learning acquired by the learning acquisition unit 102.

Specifically, the calculation unit 104 generates a mini-batch by stochastically sampling sample data of a comparable number from the first data group for learning and the second data group for learning, respectively. The mini-batch is a data set constituted of a plurality of pieces of first learning data and a plurality of pieces of second learning data.

For example, the calculation unit 104 generates a plurality of pieces of first learning data by randomly extracting 256 pieces of data from 990 pieces of data of the first data group for learning belonging to the event A while allowing the duplication. In addition, the calculation unit 104 generates a plurality of pieces of second learning data by randomly extracting 256 pieces of data from 10 pieces of data of the second data group for learning belonging to the event B while allowing the duplication. Note that the same data can be taken out many times by performing the sampling that allows the duplication. By this, the data belonging to the event B is increased in the mini-batch, and the plurality of first learning data belonging to the event A and the plurality of second learning data belonging to the event B are comparable. Since the number of multiple first learning data belonging to the event A is 256 and the number of multiple second learning data belonging to the event B is 256, a total of 512 pieces of data are used in the machine learning to be described later.

Next, the calculation unit 104 inputs each of a plurality of pieces of first learning data belonging to the first data group for learning to a first evaluation function utilized when executing the machine learning by using the first data group for learning. Then, the calculation unit 104 calculates a first covariance matrix Σ_{A} which is a covariance matrix of output values of the first evaluation function when the plurality of pieces of first learning data is inputted to the first evaluation function. This first covariance matrix Σ_{A} is calculated on the basis of 256 pieces of first learning data belonging to the event A.

In addition, the calculation unit 104 inputs each of a plurality of pieces of second learning data belonging to the second data group for learning to a second evaluation function utilized when executing the machine learning by using the second data group for learning. Then, the calculation unit 104 calculates a second covariance matrix Σ_{B} which is a covariance matrix of output values of the second evaluation function when the plurality of pieces of second learning data is inputted to the second evaluation function. This second covariance matrix Σ_{B} is calculated on the basis of 256 pieces of second learning data belonging to the event B.

The setting unit 106 calculates a weight for at least one of the first evaluation function and the second evaluation function on the basis of a value obtained from the first covariance matrix ZA and a value obtained from the second covariance matrix Σ_{B}, and sets an entire evaluation function constituted by including the weight, the first evaluation function, and the second evaluation function.

For example, the setting unit 106 calculates log det (Σ_{A}) that is a logarithmic determinant (log-determinant value) of the first covariance matrix Σ_{A} and log det (Σ_{B}) that is a logarithmic determinant (log-determinant value) of the second covariance matrix Σ_{B}. Then, the setting unit 106 calculates the weight A in accordance with the following calculation formula.

$$λ = exp ( log det ( {\sum }_{A} ) - log det ( {\sum }_{B} ) ) \qquad ( 1 )$$

Then, the setting unit 106 sets the entire evaluation function constituted by including the weight λ, the first evaluation function, and the second evaluation function, as shown in the following formula.

$$Loss ( all ) = Loss ( A ) + λ Loss ( B ) \qquad ( 2 )$$

Note that, in the above-described formula, Loss (all) is a value obtained from the entire evaluation function, Loss (A) is a value obtained from the first evaluation function, and Loss (B) is a value obtained from the second evaluation function. Loss ( ) in the above-described formula is, for example, a value representing a square error between data outputted from the learning model and correct answer data. Alternatively, for example, Loss ( ) is a value representing a sum total of an error between each of 256 pieces of first learning data belonging to the event A and the correct answer data and an error between each of 256 pieces of second learning data belonging to the event B and the correct answer data. Alternatively, for example, Loss ( ) is a value representing an average value (for example, an expected value) of errors per one piece of data, or the like.

The learning unit 108 learns the learning model on the basis of the first data group for learning, the second data group for learning, and the above-described entire evaluation function to generate the learned model. For example, the learning model is a known machine learning model. Specifically, the learning unit 108 learns the learning model so that the sum total of values outputted from the entire evaluation function becomes small when the first data group for learning and the second data group for learning are inputted to the entire evaluation function.

Since a ratio of the first data group for learning and the second data group for learning is 99:1, the value of the logarithmic determinant of the first covariance matrix Σ_{A} obtained from the plurality of pieces of first learning data tends to be larger than the logarithmic determinant of the second covariance matrix Σ_{B} obtained from the plurality of pieces of second learning data.

However, when it is assumed that the ratio of the appearance probability of the data belonging to the event A and the appearance probability of the data belonging to the event B is 1:1 at the time of estimation, it is assumed that the distribution of the data belonging to the event A and the distribution of the data belonging to the event B correspond to 1:1. Therefore, in the present embodiment, the evaluation function used for the machine learning is corrected according to variance of data at the time of learning. By this, even when only the learning data having the distribution different from the distribution of the data obtained at the time of estimation is obtained, the learned model can be generated by assuming the distribution of data obtained at the time of estimation.

The model storage unit 110 stores the learned model generated by the learning unit 108.

The acquisition unit 112 acquires target data of an estimation target.

The estimation unit 114 estimates a label of the target data by inputting the target data acquired by the acquisition unit 112 to the learned model stored in the model storage unit 110.

For example, the estimation unit 114 estimates the label indicating whether the inputted data is abnormal or normal on the basis of a known Mahalanobis distance. When the known Mahalanobis distance is used, the first covariance matrix Σ_{A} calculated from the first learning data belonging to the event A and the second covariance matrix Σ_{B} calculated from the second learning data belonging to the event B as mentioned above are used to estimate the label of the target data.

As disclosed in above-described NPL 1, the estimation unit 114 calculates an error between an output vector x′ obtained by inputting the target data to the learned model and x representing the first learning data or the second learning data. Then, the estimation unit 114 calculates the error of the Mahalanobis distance scale by multiplying a matrix representing the error between the output vector x′ and the plurality of pieces of first learning data x by an inverse matrix Σ_{A}⁻¹ of the first covariance matrix Σ_{A} from the left. In addition, the estimation unit 114 calculates the error of the Mahalanobis distance scale by multiplying a vector representing the error between the output vector x′ and a plurality of pieces of second learning data x by an inverse matrix Σ_{B}⁻¹ of the second covariance matrix Σ_{B} from the left. Then, the estimation unit 114 obtains a value in which the error of the Mahalanobis distance scale becomes the smallest as a final score. The estimation unit 114 estimates the label of the target data according to the final score.

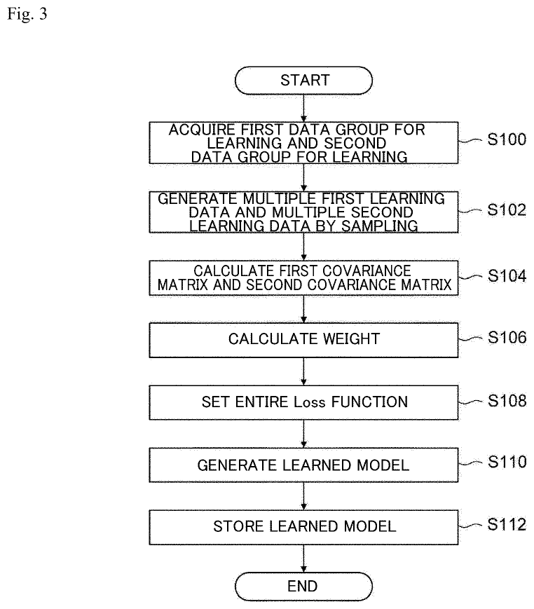

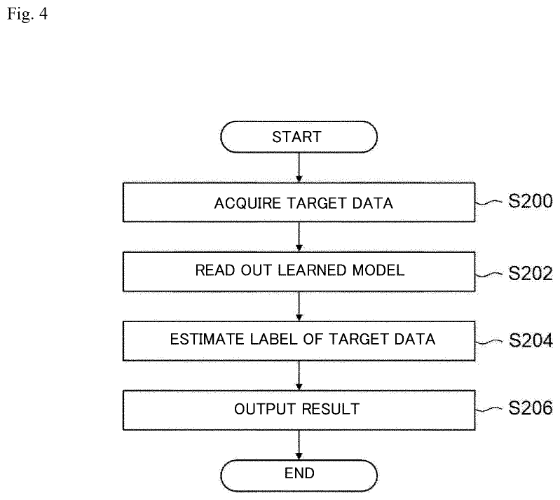

FIG. 3 is a flowchart showing one example of a flow of processing performed by the learning program according to the present embodiment. FIG. 4 is a flowchart showing one example of a flow of processes performed by the estimation program according to the present embodiment. The processing performed by the learning program is realized by the CPU 11 of the learning device 10 writing the learning program stored in the ROM 12 or the storage 14 into the RAM 13 and executing it. The processing performed by the estimation program is realized by the CPU 11 of the learning device 10 writing the estimation program stored in the ROM 12 or the storage 14 into the RAM 13 and executing it.

When receiving a control signal representing a learning instruction of the model, the learning device 10 executes the learning processing in FIG. 3.

First, in a step S100 in FIG. 3, the CPU 11 acquires, as the learning acquisition unit 102, the first data group for learning and the second data group for learning from the data storage unit 100.

In a step S102, the CPU 11 acquires, as the calculation unit 104, a plurality of pieces of first learning data by performing the sampling that allows the duplication from the first data group for learning acquired in the step S100. In addition, the calculation unit 104 acquires a plurality of pieces of second learning data learning which is approximately the same number as the plurality of pieces of first learning data by performing the sampling that allows the duplication from the second data group for learning acquired in the step S100.

In a step S104, the CPU 11 inputs, as the calculation unit 104, each of the plurality of pieces of first learning data acquired in the step S102 to the first evaluation function. Then, the calculation unit 104 calculates the first covariance matrix Σ_{A} which is a covariance matrix of output values of the first evaluation function when the plurality of pieces of first learning data is inputted to the first evaluation function. In addition, the CPU 11 inputs, as the calculation unit 104, each of the plurality of pieces of second learning data acquired in the step S102 to the second evaluation function. Then, the calculation unit 104 calculates the second covariance matrix Σ_{B} which is a covariance matrix of output values of the second evaluation function when the plurality of pieces of second learning data is inputted to the second evaluation function.

In a step S106, the CPU 11 calculates, as the setting unit 106, the weight λ in accordance with the above-described formula (1) on the basis of the logarithmic determinant obtained from the first covariance matrix Σ_{A} and the logarithmic determinant obtained from the second covariance matrix Σ_{B}.

In a step S108, the CPU 11 sets, as the setting unit 106, the entire evaluation function constituted by including the weight λ, the first evaluation function, and the second evaluation function as shown in the above-described formula (2).

In a step S110, the CPU 11 generates, as the learning unit 108, the learned model by learning the learning model on the basis of the first data group for learning, the second data group for learning, and the entire evaluation function set in the step S108.

In a step S112, the CPU 11 stores, as the learning unit 108, the learned model generated in the step S110 in the model storage unit 110.

Next, when receiving a control signal representing an estimation instruction, the learning device 10 executes the estimation processing in FIG. 4.

In a step S200, the CPU 11 acquires, as the acquisition unit 112, the target data of the estimation target.

In a step S202, the CPU 11 reads out, as the estimation unit 114, the learned model from the model storage unit 110.

In a step S204, the CPU 11 inputs, as the estimation unit 114, the target data acquired in the step S200 to the learned model read out in the step S202 to estimate the label of the target data. For example, it is estimated whether or not the target data is abnormal data.

In a step S206, the CPU 11 outputs, as the estimation unit 114, a result acquired in the step S204.

As described above, the learning device acquires the first data group for learning and the second data group for learning constituted of a smaller number of data than the number of data belonging to the first data group for learning. The learning device calculates the first covariance matrix which is a covariance matrix of output values of the first evaluation function when each of the plurality of pieces of first learning data belonging to the first data group for learning is inputted to the first evaluation function utilized when the machine learning is executed by using the first data group for learning. The learning device calculates the second covariance matrix which is a covariance matrix of output values of the second evaluation function when each of the plurality of pieces of second learning data belonging to the second data group for learning is inputted to the second evaluation function utilized when the machine learning is executed by using the second data group for learning. The learning device calculates the weight for at least one of the first evaluation function and the second evaluation function on the basis of the value obtained from the first covariance matrix and the value obtained from the second covariance matrix, and sets the entire evaluation function constituted by including the weight, the first evaluation function, and the second evaluation function. The learning device learns the learning model on the basis of the first data group for learning, the second data group for learning, and the entire evaluation function to generate the learned model. By this, even when only the learning data having the distribution different from the distribution of the data obtained at the time of estimation is obtained, the learned model can be generated by assuming the distribution of data obtained at the time of estimation.

In addition, according to the learning device of the present embodiment, by performing the sampling that allows the duplication of data, it is possible to increase data (for example, data belonging to the above-described event B) which is obtained only in a small amount. By this, the covariance matrix can be stably obtained.

In addition, according to the learning device of the present embodiment, the ratio of the logarithmic determinant of the covariance matrix of the outputs (for example, the above-described Loss (A) and Loss (B)) of the evaluation functions corresponding to the respective events is set as the weight λ. By adjusting the degree of contribution of the first evaluation function and the second evaluation function to the entire by using the weight λ, learning of the learning model can be performed in consideration of trade-off between the amount of data given as input and the appearance probability (for example, when it is assumed that the event A and the event B occur at the comparable probability, or the like) of data assumed at the time of estimation.

Further, according to the learning device of the present embodiment, it is possible to calculate the value stably by calculating the value of the determinant using a logarithm.

Note that the calculation method of the weight and the configuration method of the entire evaluation function are not limited to the above-described embodiment. For example, the following modification examples 1 to 10 can be adopted.

### Modification Example 1

The setting unit 106 may set a value obtained by dividing a value obtained from the first covariance matrix Σ_{A} by a value obtained from the second covariance matrix Σ_{B} as a weight λ for the second evaluation function, and set an entire evaluation function including the first evaluation function and the second evaluation function with the weight λ. For example, as shown by the following formula, the setting unit 106 may set a value obtained by dividing a value det (Σ_{A}) of a determinant obtained from the first covariance matrix Σ_{A} by a value det (Σ_{B}) of a determinant obtained from the second covariance matrix Σ_{B} as a weight λ.

$$Loss ( all ) = Loss ( A ) + λ Loss ( B )$$

$$λ = det ( {\sum }_{A} ) / det ( {\sum }_{B} )$$

### Modification Example 2

As shown by the following formula, the setting unit 106 may set a value obtained by dividing a value tr (Σ_{A}) of a sum of diagonal components obtained from the first covariance matrix Σ_{A} by a value tr (Σ_{B}) of a sum of diagonal components obtained from the second covariance matrix Σ_{B} as a weight λ.

$$Loss ( all ) = Loss ( A ) + λ Loss ( B )$$

$$λ = tr ( {Σ}_{A} ) / tr ( {Σ}_{B} )$$

### Modification Example 3

The setting unit 106 may set an inverse matrix of the first covariance matrix Σ_{A} as a first weight for the first evaluation function, and set an inverse matrix of the second covariance matrix Σ_{B} as a second weight for the second evaluation function. In this case, the setting unit 106 sets an entire evaluation function including the first evaluation function with the first weight and the second evaluation function with the second weight. For example, as shown by the following formula, the setting unit 106 may set the inverse matrix Σ_{A}⁻¹ obtained from the first covariance matrix Σ_{A} as the first weight for the output of the first evaluation function, and set the inverse matrix Σ_{B}⁻¹ obtained from the second covariance matrix Σ_{B} as the second weight for the output of the second evaluation function. Note that, loss ( ) in the following formula is not a scalar value but a matrix representing an error. The loss ( ) will be described later in an example.

$$Loss ( all ) = {Σ}_{A}^{- 1} * loss ( A ) + {Σ}_{B}^{- 1} * loss ( A ) + α$$

Here, α in the above-described formula is a regularization term. As the α, for example, those represented by the following formulas can be adopted. Note that α which is the regularization term may not be included in the above-described formula.

$$α = log det ( {Σ}_{A} ) + log det ( {Σ}_{B} )$$

$$α = det ( {Σ}_{A} ) + det ( {Σ}_{B} )$$

$$α = tr ( {Σ}_{A} ) + tr ( {Σ}_{B} )$$

### Modification Example 4

When the data is not increased by sampling as mentioned above, the ratio between the first learning data belonging to the event A and the second learning data belonging to the event B in the mini-batch is 99:1. In this case, in order to perform learning by assuming that the occurrence probabilities of the event A and the event B at the time of estimation are comparable, the setting unit 106 increases the weight of the event B by g as follows. By this, the contribution of the event B to the entire Loss (all) is corrected so as to be equal to the contribution of the event A.

$$Loss ( all ) = Loss ( A ) + g λ Loss ( B )$$

$$g = 99 / 1$$

By this, even when there is a large distance between the appearance probability (99:1) of data corresponding to the amount of data obtained for learning and the appearance probability (1:1) of data assumed at the time of actual estimation, the learning by assuming that the occurrence probability of the event A and the event B at the time of estimation is comparable can be performed.

### Modification Example 5

The setting unit 106 may set a value obtained by dividing the second appearance probability b by the first appearance probability a as a weight to the second evaluation function on the basis of the first appearance probability a representing a probability that data belonging to the first data group appears at the time of estimation and the second appearance probability b representing a probability that data belonging to the second data group appears at the time of estimation. In the above-described embodiment, the correction is performed on the assumption that the appearance probability of data belonging to the event A at the time of estimation and the appearance probability of data belonging to the event B at the time of estimation are comparable (1:1). However, at the time of actual estimation, when the ratio of the appearance probability of data belonging to the event A at the time of estimation and the appearance probability of data belonging to the event B at the time of estimation is not 1:1, g shown in the following is set according to the assumed appearance probability. For example, when it is known in advance that the ratio of the appearance probabilities of the event A and the event B is a:b, the setting unit 106 increases the data by data sampling to set the ratio of the data belonging to the event A and the data belonging to the event B in the mini-batch to 1:1. Then, the setting unit 106 reflects the ratio of the appearance probabilities of the event A and the event B assumed at the time of estimation on g as follows.

$$Loss ( all ) = Loss ( A ) + g λ Loss ( B )$$

$$g = b / a$$

Even when the ratio of the data belonging to the event A and the data belonging to the event B is 1:1 by the data sampling, the ratio of the contribution of the event B is corrected by the value of g. For example, when it is assumed that the ratio of the appearance probability of the data belonging to the event A and the appearance probability of the data belonging to the event B at the time of estimation is 2:1, a=2 and b=1 is set and g=½ is satisfied. In this case, the value of g is set so that the contribution of the event B is ⅓ of the entire system.

### Modification Example 6

In the above-described embodiment, the case where there are two events has been described as an example, but when there are three or more events, the following procedure may be applied. The following example is an example in which it is assumed that the ratio of the appearance probabilities of the events A, B, C and D at the time of estimation is a:b:c:d.

$$Loss ( all ) = {g}_{A} {λ}_{A} Loss ( A ) + {g}_{B} {λ}_{B} Loss ( B ) + {g}_{C} {λ}_{C} Loss ( C ) + {g}_{D} {λ}_{D} Loss ( D )$$

$${λ}_{i} = exp ( log det ( {Σ}_{i} ) ) / \{ exp ( log det ( {Σ}_{A} ) ) + exp ( log det ( {Σ}_{B} ) ) + exp ( log det ( {Σ}_{C} ) ) + exp ( log det ( {Σ}_{D} ) ) \}$$

$${g}_{i} = {r}_{i} / \{ a + b + c + d \} ( where , i represents any of A , B , C , and D )$$

In the above-described formula, each of g_{A}, g_{B}, g_{C}, and g_{D} corresponds to g in the modification example 4 or the modification example 5. rᵢ represents the ratio of the appearance probability of the event. Loss (A), Loss (B), Loss (C), and Loss (D) are values outputted from the evaluation functions when the data belonging to each of A, B, C, and Dis inputted to the evaluation function. Each of Σ_{A}, Σ_{B}, Σ_{C}, and Σ_{D} is a covariance matrix calculated from the data belonging to each of A, B, C, and D.

### Modification Example 7

Although the efficiency is somewhat deteriorated, it is also possible to omit the increase of data by sampling and to constitute the number of data used in the mini-batch at a ratio of 99:1. In this case, for example, data is acquired stochastically from a data group for learning so that the number of data belonging to the event A is set to 507 or 506, and the number of data belonging to the event B is set to 5 or 6 in the mini-match. Then, as a whole, the calculation can be performed so that the ratio of the data belonging to the event A and the data belonging to the event B is 99:1. However, in this case, the covariance matrix cannot be obtained correctly, and the calculation may become unstable.

### Modification Example 8

Instead of calculating the covariance matrices Σ_{A} and Σ_{B} for each mini-batch, the covariance matrices may be calculated using data in a set of mini-batches for one epoch. In this case, when the repetitive learning is executed, the covariance matrices Σ_{A} and Σ_{B} of the epoch at the current stage are calculated for the covariance matrices obtained for all the data of the previous epoch.

### Modification Example 9

In the above description, the average of the covariance matrices obtained for each mini-batch may be the entire covariance matrices Σ_{A} and Σ_{B}.

### Modification Example 10

In the above-described embodiment, the case where the weight λ and the Loss (all) are represented by the above-described formula (1) and the above-described formula (2) has been described as an example, but it is not limited thereto. For example, the weight λ and the Loss (all) may be calculated by the following formula (1A) and formula (2A).

$$λ = exp ( log det ( {Σ}_{B} ) ) / exp ( log det ( {Σ}_{A} ) ) = exp ( log det ( {Σ}_{B} ) - log det ( {Σ}_{A} ) ) \qquad ( 1 A )$$

$$Loss ( all ) = λ Loss ( A ) + Loss ( B )$$

### (2A)

In the above-described case, the setting unit 106 sets the value obtained by dividing the value obtained from the second covariance matrix Σ_{B} by the value obtained from the first covariance matrix Σ_{A} as the weight λ for the first evaluation function, and sets the entire evaluation function including the first evaluation function with the weight λ and the second evaluation function.

### EXAMPLE

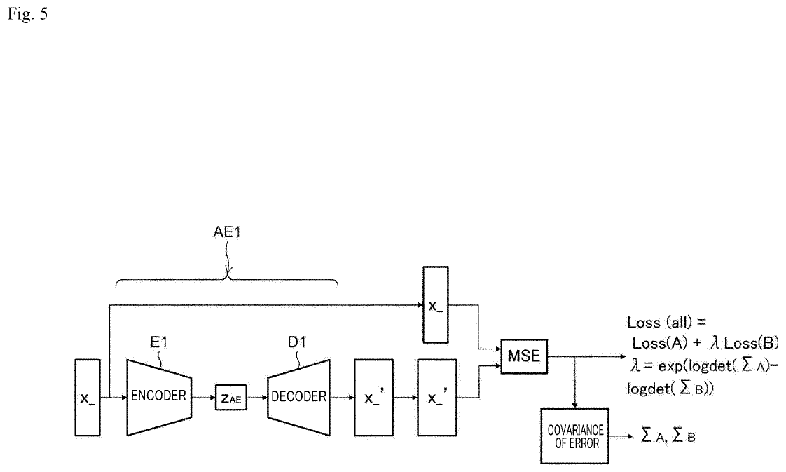

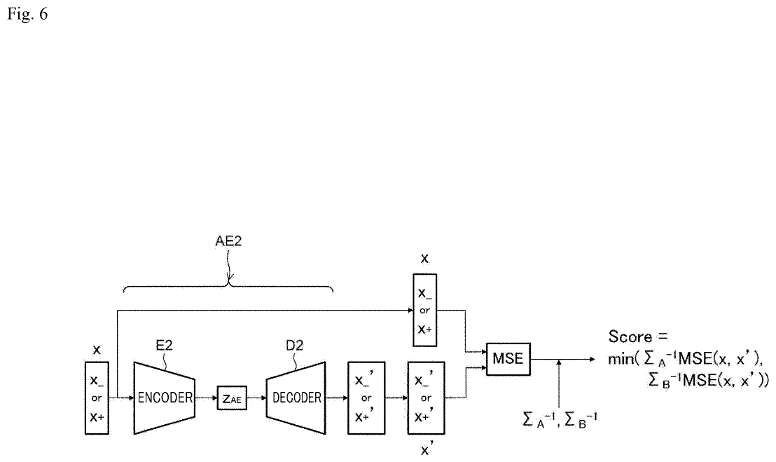

Next, an example in which the present embodiment is applied to a means for detecting an abnormality of equipment by using an autoencoder will be described. FIG. 5 and FIG. 6 are diagrams for explaining the example. FIG. 5 is a diagram for explaining a flow of processing when an autoencoder AE1 which is a learning model is learned. FIG. 6 is a diagram for explaining a flow of the processing when the estimation processing is executed by using a learned autoencoder AE2.

In this abnormality detection means, it is assumed that the autoencoder AE2 learned only from normal data x₋ has a large reconfiguration error with respect to the input of abnormal data x₊. Then, it is judged whether the inputted data is normal or abnormal according to the magnitude of the reconfiguration error. That is, when the reconfiguration error when the target data is inputted to the learned autoencoder AE2 exceeds a threshold value set in advance by learning, it is judged to be abnormal, and when the reconfiguration error is equal to or less than the threshold value, it is judged to be normal.

### [Regarding Data]

In the present example, acoustic data emitted from the equipment is defined as target data. 990 pieces of learning data when the equipment is operating under an operation condition A are prepared, and 10 pieces of learning data when the equipment is operating under an operation condition B are prepared. The time length of these pieces of learning data is 10 seconds. These pieces of acoustic data are read by a computer, and these pieces of acoustic data are divided into consecutive frames in time-series while shifting them at a step width of 512 points with 1024 points in the acoustic data as one frame. Then, each frame obtained from the acoustic data is frequency-converted by FFT (Fast Fourier Transform) at 1024 points. Then, the frequency conversion result is further converted into a mel spectrum of 128 points.

And the mel spectrum after conversion is divided into time-series unit units in which partial time overlaps while shifting the mel spectrum in a time direction one by one with consecutive five frames as one unit. Learning and estimation are performed by using the five frames one packet as a basic unit. This one packet is utilized as normal data x₋ and abnormal data x₊.

### [Learning of Autoencoder]

As mentioned above, it is assumed that 990 pieces of learning data for 10 seconds in which normal operation sounds of the operation condition A are recorded are provided, and 10 pieces of learning data for 10 seconds in which normal operation sounds of the operation condition B are recorded are provided, respectively. The abnormal data is not provided at the time of learning.

As shown in FIG. 5, the autoencoder AE1 is learned by using only the provided normal data x₊. Then, as shown in FIG. 6, a system is constituted to judge whether the operation sound represented by the data is normal or abnormal by inputting data of 10 seconds in which it is unknown which of the data belongs to the operation condition A or the operation condition B, and whether the data is normal or abnormal at the time of evaluation.

As shown in FIG. 5, the autoencoder AE1 is constituted by including an encoder E1 and a decoder D1. In the present example, whether the inputted data is normal or abnormal is estimated by using the autoencoder AE1. Specifically, as shown in FIG. 5, only the normal data x₋ is utilized as learning data to learn the autoencoder AE1. In this case, the learning is executed so that an MSE (Mean Squared Error) which is an error between data x₋′ encoded and decoded by the autoencoder AE1 and learning data x₋ is minimized. Here, the normal data x₋ includes data belonging to the operation condition A and data belonging to the operation condition B. The value Loss (A) outputted from the first evaluation function and the value Loss (B) outputted from the second evaluation function are represented by the following formula. Note that the Encode ( ) represents an output from the encoder E1, and the Decode ( ) represents an output from the decoder D1.

$$Loss ( A / B ) = MSE ( {x}_{-} , {x}_{-}^{′} )$$

$$Here , {x}_{-}^{′} = Decode ( Encode ( {x}_{-} ) )$$

Then, in the learning using the mini-batch, the covariance matrices Σ_{A} and Σ_{B} of the error are calculated after the end of the last epoch. Specifically, Σ_{A} and Σ_{B} are separately calculated for each of the operation condition A and the operation condition B, respectively. Note that Σ_{A} and Σ_{B} may be calculated by using learning data in the mini-batch, or may be calculated by using all the learning data of the operation conditions A and B used for epochs as shown in the above-described modification example 9. In addition, similarly to the above-described embodiment, Loss (all) and λ are calculated by the following formula.

$$Loss ( all ) = Loss ( A ) + λ Loss ( B )$$

$$λ = exp ( log det ( {Σ}_{A} ) - log det ( {Σ}_{B} ) )$$

Hereinafter, more detailed description will be given.

The data processing as mentioned above is executed on 990 pieces of normal acoustic data belonging to the operation condition A and 10 pieces of normal acoustic data belonging to the operation condition B. Then, by executing the random sampling as mentioned above, 512 packets in total of 256 packets of data belonging to the operation condition A and 256 packets of data belonging to the operation condition B are extracted as the mini-batch. Note that the i-th packet among a plurality of packets belonging to the operation condition A in the mini-batch is represented as Aᵢ. In addition, the i-th packet among a plurality of packets belonging to the operation condition B in the mini-batch is represented as Bᵢ.

Note that, since the data in one packet is a concatenation of 128 dimensional mel spectra for 5 consecutive frames, it is a 640 dimensional vector. Therefore, the j-th element of a vector Aᵢ and a vector Bᵢ corresponds to a value of the j-th frequency bin. The value of the frequency bin represents the intensity of a predetermined frequency region in the frequency analysis result.

As shown in FIG. 5, the normal data x₋ corresponding to the 640 dimensional vector Aᵢ or Bᵢ is inputted to the autoencoder AE1 before learning. As shown in FIG. 5, the normal data x₋ inputted to the autoencoder AE1 is restored by the decoder D1 through the bottleneck layer from the encoder E1. Note that z_{AE} shown in FIG. 5 represents a latent vector. The decoder D1 outputs restored data x₋′ of the normal data x₋. The restored data x₋′ corresponds to the restored vector Aᵢ′ or Bᵢ′. Then, as shown in FIG. 5, the autoencoder AE1 is learned so as to minimize the MSE which is the error between the restored data x₋′ and the normal data x₋. Here, the error between the individual input vector Aᵢ or Bᵢ and the individual restored vector Aᵢ′ or Bᵢ′ is represented by the following formula.

$$Loss ( A ) = sum ( loss ( {A}_{i} ) ) [ 0 <= i < 512 ]$$

$$Loss ( B ) = sum ( loss ( {B}_{i} ) ) [ 0 <= i < 512 ]$$

Here, the loss ( ) of loss (Aᵢ) and loss (Bᵢ) is defined below.

$$loss ( {A}_{i} ) = D ( {A}_{i} , {A}_{i}^{′} )$$

$${A}_{i}^{′} = Dec ( Enc ( {A}_{i} ) )$$

$$Loss ( {B}_{i} ) = D ( {B}_{i} , {B}_{i}^{′} )$$

$${B}_{i}^{′} = Dec ( Enc ( {B}_{i} ) )$$

Here, Aᵢ′ is a decoded vector obtained by performing encoding (Enc ( )) and decoding (Dec ( )) by the autoencoder with 640 dimensional Aᵢ as an input, and the error D is defined as a square error represented by the following formula.

$$D ( {A}_{i} , {A}_{i}^{′} ) = MSE ( {A}_{i} , {A}_{i}^{′} ) = sum ( ( {A}_{i} [ j ] - {A}_{i}^{′} [ j ] ) \hat{} 2 ) [ 0 <= j < 640 ]$$

The covariance matrices Σ_{A} and Σ_{B} are calculated as follows using N=512 640 dimensional vectors Aᵢ and Bᵢ in the mini-batch. In the following description, only the calculation method of the covariance matrix Σ_{A} is shown, but the covariance matrix Σ_{B} is similar.

When the i-th element among the N Aᵢ is represented as Aᵢ and the j-th element of the Aᵢ which is the 640 dimensional vector is represented as Aᵢ [j], the covariance matrix Σ_{A} becomes a 640×640 dimensional matrix. Then, an error dAᵢ [j] between the j-th element of Aᵢ and the j-th element of Aᵢ′ is represented by the following formula. In addition, the average error μ_{dAi} calculated from the error dAᵢ [j] is represented by the following formula. Then, on the basis of the error dAᵢ and the average error μ_{dAi}, the covariance matrix Σ_{A} corresponding to the operation condition A is calculated by the following formula.

$${dA}_{i} [ j ] = ( {A}_{i} [ j ] - {A}_{i}^{′} [ j ] )$$

$${μ}_{dAi} = sum ( {dA}_{i} [ j ] ) / N [ 0 <= i < N , 0 <= j < 640 ]$$

$${Σ}_{A} = \frac{1}{N - 1} {\sum }_{i = 0}^{N - 1} ( {d}_{Ai} - {μ}_{dAi} ) {( {d}_{Ai} - {μ}_{dAi} )}^{T}$$

Here, the covariance matrix is made unbiased variance and is calculated by dividing it by N−1 obtained by reducing the degree of freedom by 1.

Note that, in the present example, the covariance matrix is made unbiased variance and divided by N−1 in which the degree of freedom is reduced by 1, but it may be divided by N instead of N−1 as a calculation of sample variance in another embodiment (in the example of above-described NPL 1, obtaining the sample variance by dividing by N is defined and this is general, but it is preferable to use the unbiased variance divided by N−1 because of its good performance).

Then, the entire evaluation function is calculated by the following formula using Σ_{A} and Σ_{B} obtained described above.

$$Loss ( all ) = Loss ( A ) + λ Loss ( B )$$

$$λ = exp ( log det ( {Σ}_{A} ) - log det ( {Σ}_{B} ) )$$

Here, log det (Σ_{A}) and log det (Σ_{B}) are values of the logarithmic determinant of covariance matrices Σ_{A} and Σ_{B} of a plurality of pieces of data in the current mini-batch.

Note that the number of data belonging to the operation condition B is increased by performing the sampling that allows the duplication, so that 256 pieces of data are present in the mini-batch. Therefore, the Loss (B) of the operation condition B is calculated based on the data in the mini-batch, so that the covariance matrix Σ_{B} can be stably calculated. In addition, the Loss (A) of the operation condition A is also calculated by using the equal number of 256 pieces of data. However, since the data of the operation condition B is sampled at random while allowing the duplication, an information amount is not so large. Therefore, the data of the operation condition B cannot contribute to the learning and may cause overlearning.

In the present example, similarly to the above-described embodiment, the weight λ is calculated by using the ratio of the values of the logarithmic determinant of the covariance matrix, and the evaluation function is corrected by the weight λ. By this, learning of the autoencoder AE1 can be performed by using the evaluation function for minimizing the error when the ratio of the appearance probability of data belonging to the operation condition A and the appearance probability of data belonging to the operation condition B is normalized to 1:1.

Specifically, the weight λ corresponds to the calculation using the ratio of the variance of the error to the data belonging to the operation condition A and the variance of the error to the data belonging to the operation condition B. Therefore, for example, when a Mahalanobis distance of a square error reference is used, it is possible to perform learning so as to minimize the error by increasing the weight for the data in which the error is increased as the ratio of the appearance probability of data belonging to the operation condition A and the appearance probability of data belonging to the operation condition B is normalized to 1:1.

Note that, in order to calculate the Mahalanobis distance in the evaluation function Loss (all)=Σ_{A}⁻¹*loss (A)+Σ_{B}⁻¹*loss (B) in the above-described modification example 3, it is necessary to calculate the inverse matrix of the 640×640 dimensional covariance matrix twice of Σ_{A}⁻¹ and Σ_{B}⁻¹ for each learning epoch. This calculation is not practical because the calculation cost is high even if the calculation to be described later is simplified (modification examples 1 and 2 to be described later).

On the other hand, when λ=exp (log det (Σ_{A})−log det (Σ_{B})), which is the proposed method in the present example and the present embodiment, is used, the value can be calculated with a very small amount of computation of only the value of the determinant instead of calculating the inverse matrix. The correction of the evaluation function in the present example and the present embodiment corresponds to the correction of the contribution rates of Loss (A) and Loss (B) to be close to the ratio of the contribution rates after applying the inverse matrix by using the magnification represented by the determinant. Note that the magnification of the permutation matrix corresponds to the reciprocal of the magnification of the inverse matrix.

### [Detection of Abnormality by Estimation]

Acoustic data to be evaluated is inputted to the learned autoencoder AE2 obtained by the above-mentioned learning method. Note that, as shown in FIG. 6, the packet x₋ of normal acoustic data and the packet x₊ of abnormal acoustic data are inputted to the autoencoder AE2. Note that, these pieces of data belong to either the operation condition A or the operation condition B. Based on the output vector from the learned autoencoder AE2, it is judged whether the inputted data is normal sound or abnormal sound.

The acoustic data to be evaluated is converted into data in units of one packet by performing data processing as mentioned above. Data of one packet is inputted to the learned autoencoder AE2 with one packet as a basic unit. Then, as shown in FIG. 6, the MSE is calculated, which is the square error between the inputted packet x and the reconfiguration packet x′ encoded and decoded by the learned autoencoder AE2.

Next, an error MD ( ) on the Mahalanobis distance scale obtained by multiplying the MSE which is a square error by inverse matrices Σ_{A}⁻¹ and Σ_{B}⁻¹ of covariance matrices Σ_{A} and Σ_{B} of errors to the packet x₋ of normal data calculated at the time of learning from the left is calculated as a degree of abnormality. By this, the value of the frequency bin where the variance of the error is large in the packet x⁻ input of the normal data is evaluated small, and the value of the frequency bin where the variance of the error is small in the packet x₋ input of the normal data is evaluated large. By this, the error can be evaluated by the Mahalanobis distance. The Score representing the degree of abnormality is calculated by the following formula.

$$Score = min ( MD ( x , {x}^{′} , {Σ}_{A}^{- 1} ) , MD ( x , {x}^{′} , {Σ}_{B}^{- 1} ) )$$

$${x}^{′} = Decode ( Encode ( x ) )$$

Then, when the Score indicating the degree of abnormality exceeds a threshold value set in advance at the time of learning, it is judged to be abnormal, and when the degree of abnormality is equal to or less than the threshold value, it is judged to be normal.

### Modification Example 1

### (Reduction 1 of Computation Amount by Simplified Approximation of Covariance Matrix Used at Time of Estimation and Learning)

The covariance matrix of error in the above-mentioned example is a 640×640 dimensional covariance matrix of errors between 640 dimensional vectors Aᵢ and Aᵢ′.

However, since Aᵢ is originally a concatenation of 128 dimensional mel spectra for five consecutive frames, the covariance may be calculated as a block diagonal matrix for every 128 dimensions in 640×640 dimensions as 5 frames per 128 dimensions.

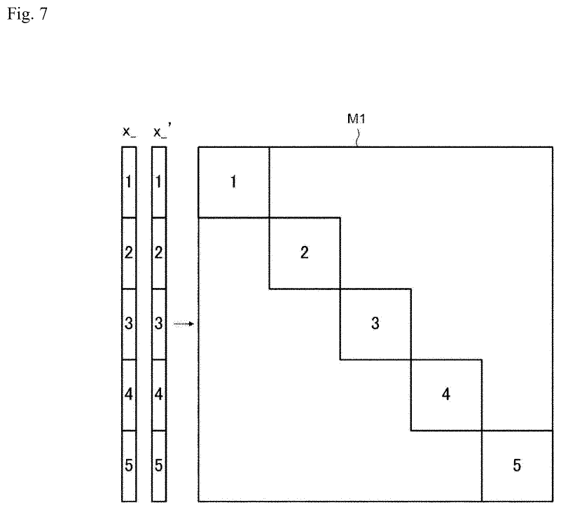

FIG. 7 is a diagram for explaining the block diagonal matrix obtained by simplified approximation of the covariance matrix. As shown in FIG. 7, five 128×128 dimensional blocks are arranged diagonally and constituted in a covariance matrix M1 of 640×640 dimensions, and elements of non-diagonal blocks are set to 0. This simplification corresponds to a calculation that takes into account the relationship between each frequency bin of the mel spectrum in the frame, but ignores the relationship between frequency bins across frames.

By this, the calculation of the inverse matrix at the time of estimation can be reduced from a 640×640 dimensional inverse matrix calculation to only five 128×128 dimensional inverse matrix calculations. Then, for the calculation of the value of the degree of abnormality score at the time of estimation, the Mahalanobis distance scale calculated by multiplying the error matrix by the inverse matrix of the matrix in which five 128×128 dimensional blocks are arranged diagonally from the left is used.

### Modification Example 2

### (Reduction 2 of Computation Amount by Simplified Approximation of Covariance Matrix Used at Time of Estimation and Learning)

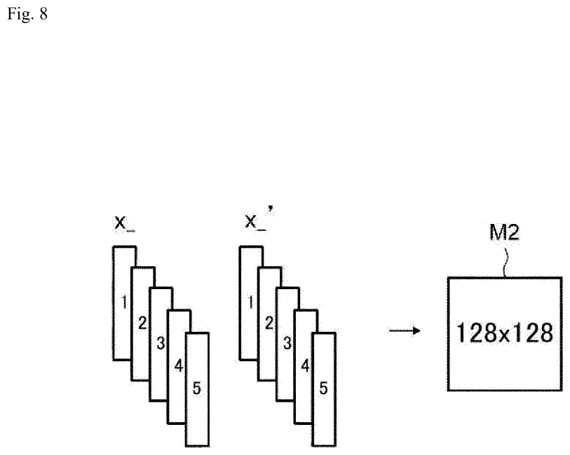

The block diagonal matrix of the above-described modification example 1 is further improved to calculate the 128×128 dimensional covariance matrix by interpreting the vector Aᵢ in the mini-batch as 5N frames of 128 dimensions instead of interpreting it as having N packets of 640 dimensions. FIG. 8 is a diagram for explaining a covariance matrix obtained by simplified approximation of the covariance matrix. As shown in FIG. 8, a 128×128 dimensional covariance matrix M2 may be calculated.

By this, at the time of estimation, while originally the 640×640 dimensional inverse matrix calculation is required, it can be simplified to the 128×128 dimensional inverse matrix calculation. Since the calculation of the inverse matrix generally takes the order of the third power of the dimension n, the computation amount can be dramatically reduced by subtracting n=640 to n=128.

Although n=640 is satisfied only by processing successive five frames, when the number of unit frames to be inputted is further increased to 128 frames, n=128\hat{ }2 is satisfied, and the inverse matrix of matrix of size of 128\hat{ }2×128\hat{ }2 needs to be calculated. On the other hand, by using the present modification example 2, it is only necessary to calculate the inverse matrix of 128×128 dimensional matrix.

Note that, although the case where the learning device 10 executes the learning processing of the model and the estimation processing has been described as an example in the above-described embodiment, it is not limited thereto. For example, the learning device may execute the learning processing of the model, and the estimation device may execute the estimation processing.

The processing performed by the CPU 11 reading and executing each program in the above-described embodiment may be executed by various processors other than the CPU 11. As the processor in this case, a PLD (Programmable Logic Device) whose circuit configuration can be changed after manufacturing, such as an FPGA (Field-Programmable Gate Array), and a dedicated electric circuit that is a processor having a circuit configuration designed as a dedicated configuration to execute specific processing, such as an ASIC (Application Specific Integrated Circuit), or the like are illustrated. In addition, each processing may be executed by one of these various processors, or may be executed by a combination of two or more processors of the same type or different types (for example, a combination of a plurality of FPGAs, a combination of a CPU and an FPGA, and the like). In addition, more specifically, a hardware structure of these various processors is an electrical circuit in which circuit elements such as semiconductor elements are combined.

In addition, in the above-described embodiment, an aspect has been described in which the program is previously stored (called “installed”) in the ROM 12 or the storage 14, however, it is not limited thereto. The customer number prediction program may be provided in a form in which the program is stored in a non-transitory storage medium such as a CD-ROM (Compact Disk Read Only Memory), a DVD-ROM (Digital Versatile Disk Read Only Memory), or a USB (Universal Serial Bus) memory. In addition, the program may be provided in a form to be downloaded from an external device via a network.

All documents, patent applications, and technical standards described in the present specification are incorporated by reference in the present specification to the same extent as when each document, patent application, and technical standard is specifically and individually described to be incorporated by reference.

Regarding the above embodiment, the following supplement are further disclosed.

### (Supplement Item 1)

A learning device includes a memory and
at least one processor connected to the memory, wherein
the processor
acquires a first data group for learning and a second data group for learning constituted of smaller data than the number of data belonging to the first data group for learning,
calculates a first covariance matrix that is a covariance matrix of output values of a first evaluation function when each of a plurality of pieces of first learning data belonging to the first data group for learning is inputted to the first evaluation function utilized when machine learning is executed using the first data group for learning,
calculates a second covariance matrix that is a covariance matrix of output values of a second evaluation function when each of a plurality of pieces of second learning data belonging to the second data group for learning is inputted to the second evaluation function utilized when the machine learning is executed using the second data group for learning,
calculates a weight for at least one of the first evaluation function and the second evaluation function based on a value obtained from the first covariance matrix and a value obtained from the second covariance matrix and sets an entire evaluation function constituted by including the weight, the first evaluation function, and the second evaluation function, and generates a learned model by learning a learning model based on the first data group for learning, the second data group for learning, and the entire evaluation function.

### (Supplement Item 2)

A non-transitory storage for storing a program that can be executed by a computer to perform learning processing, wherein
the learning processing includes
acquiring a first data group for learning and a second data group for learning constituted of smaller data than the number of data belonging to the first data group for learning,
calculating a first covariance matrix that is a covariance matrix of output values of a first evaluation function when each of a plurality of pieces of first learning data belonging to the first data group for learning is inputted to the first evaluation function utilized when machine learning is executed using the first data group for learning,
calculating a second covariance matrix that is a covariance matrix of output values of a second evaluation function when each of a plurality of pieces of second learning data belonging to the second data group for learning is inputted to the second evaluation function utilized when the machine learning is executed using the second data group for learning,
calculating a weight for at least one of the first evaluation function and the second evaluation function based on a value obtained from the first covariance matrix and a value obtained from the second covariance matrix and setting an entire evaluation function constituted by including the weight, the first evaluation function, and the second evaluation function, and
generating a learned model by learning a learning model based on the first data group for learning, the second data group for learning, and the entire evaluation function.

### REFERENCE SIGNS LIST

10 Learning device
100 Data storage unit
102 Learning acquisition unit
104 Calculation unit
106 Setting unit
108 Learning unit
110 Model storage unit
112 Acquisition unit
114 Estimation unit

1. A learning device comprising:
a memory; and
at least one processor connected to the memory,
the at least one processor is configured to:
acquire a first data group for learning and a second data group for learning constituted of a smaller number of data than the number of data belonging to the first data group for learning;
calculate a first covariance matrix that is a covariance matrix of output values of a first evaluation function when each of a plurality of pieces of first learning data belonging to the first data group for learning is inputted to the first evaluation function utilized when machine learning is executed using the first data group for learning;
calculate a second covariance matrix that is a covariance matrix of output values of a second evaluation function when each of a plurality of pieces of second learning data belonging to the second data group for learning is inputted to the second evaluation function utilized when the machine learning is executed using the second data group for learning;
calculate a weight for at least one of the first evaluation function and the second evaluation function based on a value obtained from the first covariance matrix and a value obtained from the second covariance matrix and set an entire evaluation function constituted by including the weight, the first evaluation function, and the second evaluation function; and
generate a learned model by learning a learning model based on the first data group for learning, the second data group for learning, and the entire evaluation function.

2. The learning device according to claim 1, wherein the processor is configured to:
set a value obtained by dividing a value obtained from the first covariance matrix by a value obtained from the second covariance matrix as the weight for the second evaluation function and sets the entire evaluation function including the first evaluation function and the second evaluation function with the weight.

3. The learning device according to claim 1, wherein the processor is configured to:
set a value obtained by dividing a value obtained from the second covariance matrix by a value obtained from the first covariance matrix as the weight for the first evaluation function and sets the entire evaluation function including the first evaluation function with the weight and the second evaluation function.

4. The learning device according to claim 1, wherein the processor is configured to:
acquire a plurality of pieces of first learning data by performing sampling that allows duplication from the first data group for learning,
acquire a plurality of pieces of second learning data by performing the sampling that allows the duplication from the second data group for learning,
calculate the first covariance matrix that is a covariance matrix of output values of the first evaluation function when each of the plurality of pieces of first learning data is inputted to the first evaluation function, and
calculate the second covariance matrix that is a covariance matrix of output values of the second evaluation function when each of the plurality of pieces of second learning data is inputted to the second evaluation function.

5. The learning device according to claim 1, wherein the processor is configured to:
set a value obtained by dividing a second appearance probability by a first appearance probability as a weight for the second evaluation function based on the first appearance probability representing a probability that data belonging to the first data group appears at the time of estimation and the second appearance probability representing a probability that data belonging to the second data group appears at the time of estimation.

6. An estimation device comprising:
an acquisition unit configured to acquire target data; and
an estimation unit configured to estimate a label of the target data by inputting the target data to a learned model obtained by the learning device according to claim 1.

7. A learning method in which a computer executes processing, comprising:
by a processor,
acquiring a first data group for learning and a second data group for learning constituted of smaller data than the number of data belonging to the first data group for learning;
calculating a first covariance matrix that is a covariance matrix of output values of a first evaluation function when each of a plurality of pieces of first learning data belonging to the first data group for learning is inputted to the first evaluation function utilized when machine learning is executed using the first data group for learning;
calculating a second covariance matrix that is a covariance matrix of output values of a second evaluation function when each of a plurality of pieces of second learning data belonging to the second data group for learning is inputted to the second evaluation function utilized when the machine learning is executed using the second data group for learning;
calculating a weight for at least one of the first evaluation function and the second evaluation function based on a value obtained from the first covariance matrix and a value obtained from the second covariance matrix and setting an entire evaluation function constituted by including the weight, the first evaluation function, and the second evaluation function; and
generating a learned model by learning a learning model based on the first data group for learning, the second data group for learning, and the entire evaluation function.

8. A non-transitory computer-readable storage medium storing a program that causes a computer to perform a learning process and to function as the learning device described in claim 1.
